(19) United States
(12) Patent Application Publication
(10) Pub. No.: US 2007/0172303 A1
(43) Pub. Date: Jul. 26, 2007

(54) Soap bar with insert

(76) Inventor: Justin Ho, Rowland Heights, CA (US)

Correspondence Address: LAW OFFICES OF CLEMENT CHENG, 17220 NEWHOPE STREET #127, FOUNTAIN VALLEY, CA, 92708, US

(21) Appl. No.: 11/340,187

(22) Filed: Jan. 26, 2006

(51) Int. Cl. B43K 5/02

(52) U.S. Cl. 401/143

(57) ABSTRACT

A bar of soap has a soap outside layer, and an insert. The insert may have a sliver shaped tube with an opening, where the sliver shaped tube holds body lotion, or a semiconductor core encapsulated by an epoxy intermediate layer.

### BACKGROUND OF THE INVENTION

A. Field of the Invention

The present invention relates to soap. More particularly, the present invention relates to a hybrid soap bar structure providing new valuable inserts in capsule in place of wastage at the dissolution of the soap bar.

B. Description of the Prior Art

Soap in a bar form has been the popular and became more important cleansing means for its convenience of handling at a low cost as the public is threatened with new diseases like bird flu spreading among growing population where maintaining individual sanitations is emphasized. So, soap is easily found at water faucets as a bathroom staple.

Several squeezes and turning of soap in wet hands leave a good amount of lather to clean the hands and the other part of the body. At the end of life of the soap it shrinks to a sliver size inconvenient to use or frustrating to the last user unless the toilet keeper remembers the early replacement such as at one third of its full size. It has been suggested to solve the problem by using various foreign inserts with or without an enclosure to replace the sliver waste at the manufacture of the soap.

However, to the inventor's knowledge no idea has been suggested to compensate the trouble of the last user with a valuable reward of detergent replacement, which promotes the use of soap and even encourages a faster replenishment of soap. There were no such inserts with a higher value to practically draw interests to the above solution in which the present invention involves to improve.

Conventional sense is that such sliver replacements be minor under the cost of the soap itself even if it is not detergent. For example, a sealed printed matter was suggested for a saving coupon or a collectible as well as a body of stick as a safety means to prevent a child to try to swallow the soap sliver. Also, a scented core was offered to replace the center portion of the soap.

Because the soap is generally inexpensive, this low price approach has limited effect where an additional process does not offset the additional manufacturing cost in dealing with cheap article insets.

Representative prior arts show a variety of soap saving devices created to conserve soap. Sampson U.S. Pat. No. 6,799,917 describes a retention ring for holding a bar of soap. Hoffman U.S. Pat. No. 4,501,354 presents a bonding strap used to bond multiple pieces of soap.

Soap can receive an insert, such as the insert shown in Lindauer U.S. Pat. No. 4,453,909 the disclosure of which is incorporated herein by reference. A typical insert is a perfumed core, or as described in the background a double part casing holding an attractive figure or toy. The current state of the art provides methods of producing soap having inserts. A soap bar factory can use any of these methods of producing soap bars with inserts.

Di Giovanna U.S. Pat. No. 4,308,157 presents additional inserts such as: “It may comprise a coin 14 such as a penny or nickel; it may be a money-saving coupon 15 for the next purchase of soap; or it may comprise an item to save such as a unique postage stamp for starting a postage stamp collection, or any other item of interest. As a bottle, it may contain an interesting perfume 16. A removable small cap 17 screwed on the bottle closes an opening used for access to the perfume.”

While the above improvements make the bar of soap interesting to a level, additional improvements may be made to further improve the soap bar insert and make it more attractive for a user.

Accordingly, the object of the present invention is to provide a soap bar with such an insert to eliminate the inconveniences with soap slivers left for indefinite duration of time by replacing the same with an incentive article that will be carried off before any sliver forms.

### SUMMARY OF THE INVENTION

A bar of soap has a soap outside layer, and an insert. The insert may have a sliver shaped tube with an opening, where the sliver shaped tube holds body lotion. The tube in the soap bar is sliver shaped.

A second embodiment of the inventive soap bar further comprises a soap outside layer; an epoxy intermediate layer; and a semiconductor core. The soap bar has the epoxy intermediate layer entirely encapsulates the semiconductor core, wherein the epoxy intermediate layer has an outside surface having a sliver shape.

### BRIEF DESCRIPTION OF THE DRAWINGS

FIG. 1 is a perspective view of the soap bar of the present invention as seen in the first embodiment with a first insert.

FIG. 2 is a perspective view of the insert of the first embodiment of FIG. 1 in use at the consumption of the soap.

FIG. 3 is a perspective view of the soap bar of the present invention as seen in the second embodiment with a second insert.

FIG. 4 is a perspective view of second insert in operation partly shown in phantom lines for a clear view of an article inset.

FIG. 5 is a perspective view of a smooth edge embodiment.

FIG. 6 is a perspective view of a double chambered insert.

Similar reference numbers denote corresponding features throughout the attached drawings.

### DETAILED DESCRIPTION OF THE PREFERRED EMBODIMENT

With reference to FIG. 1, an ellipsoidally-shaped soap bar 1 according to the first embodiment of the present invention is embedded with a tube insert 2. The soap bar 1 may be extruded from a solution of mixtures including liquid soap, perfumes, colorants, abrasives, bleaches, fillers, emollients and bodying agents like gelatin.

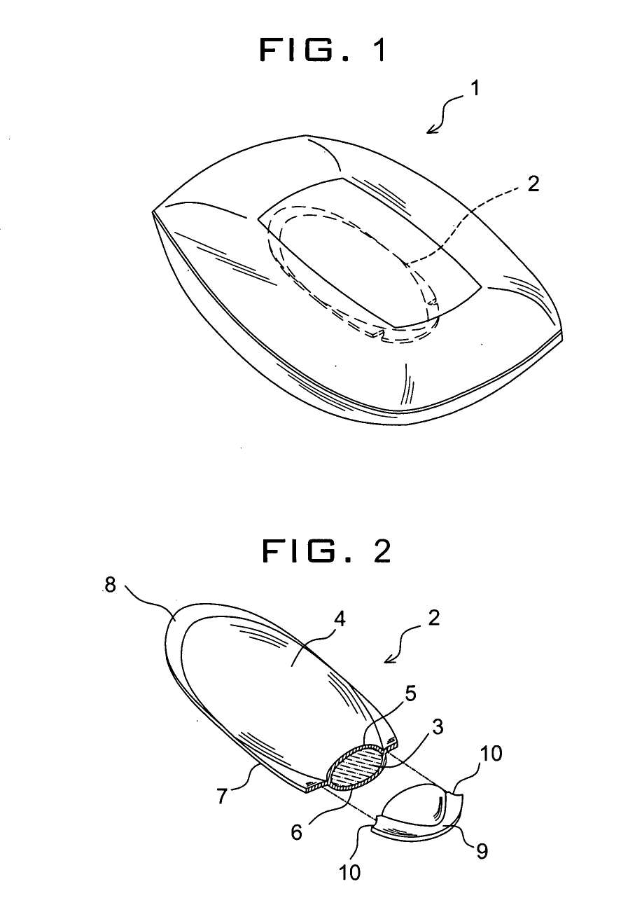

In FIG. 2, body lotion with a cleansing agent 3 is encapsulated within the tube insert 2. The insert 2 is a closed tube shaped into a sliver form to which the soap bar 1 will be reduced when it is consumed. The sliver is a remnant of soap that is thin having a basically oval shaped cross section in every cartesian plane. The sliver arises from normal use of the bar of soap. After a user consumes the bar of soap, the sliver shaped tube 2 can be twist or tear-opened for use.

In FIG. 2, liquid soap can alternatively comprise the agent 3 encapsulated within the insert 2. The liquid soap can be a liquid soap version of the soap bar with the same trademark imprinted on the insert 2. The insert can alternatively be made as a flexible heat laminated thin walled plastic pouch commonly in use in sample packaging. The thin walled plastic pouch can be made in an elliptical shape when viewed from above. The heat laminated thin walled version may have a heat laminated portion where an upper wall is bonded to a lower wall.

The tube 2 has an elongated convex body 4 and comprises an upper shell 5 and a lower shell 6, which are heat formed at their peripheral sections 7. The tube 2 has a rear end 8, which may be first closed for filling with lotion 3 and a front end 9. The front end 9 of the tube 2 is preferably a single use package that has scored or notched opening 10, which can be manually torn opened. The tube 2 can be made of plastic suitable for heat sealing. Once the insert 2 is exposed at the dissolution of the soap 1 the user can open the seal at the scored or notched opening 10 for an easy access to the lotion for extra cleaning and body nourishment.

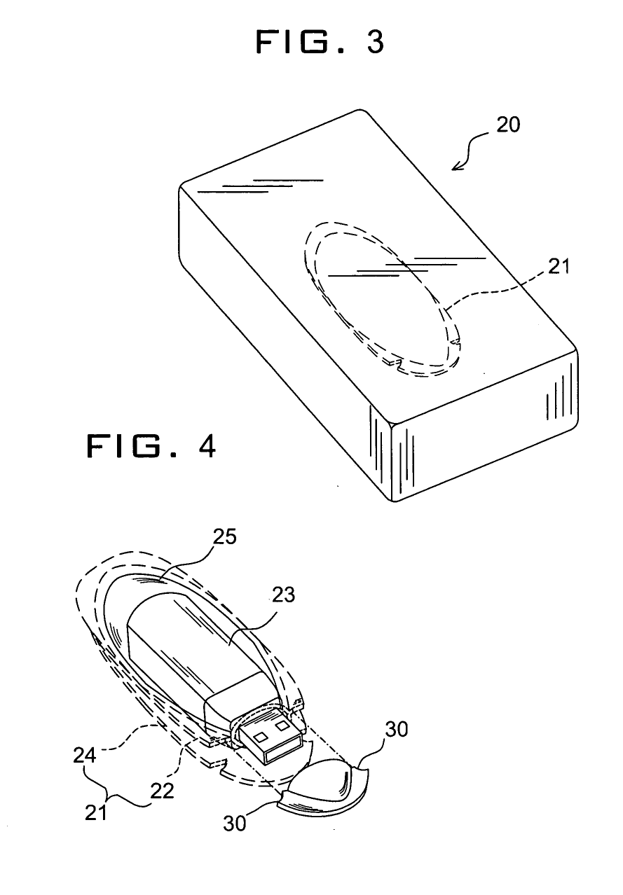

Referring to FIGS. 3 and 4 showing the second embodiment of the present invention, a bar of soap 20 in a rectangular parallelepiped-shape has a twin tube 21 comprising a first tube 22 for containing an encapsulated small electronic device 23 inside a second tube 24 that is similar to the lotion tube 2 in FIG. 2. The device 23 is first encapsulated within a waterproof and shock coating 25 comprising an epoxy or gel resin that forms the first tube 22, which is put inside a second tube 24. Preferably, the epoxy resin intermediate layer 25 is sliver shaped and of sufficient thickness to absorb mechanical shock associated with normal soap bar usage. The twin tube 21 is then put in the soap 20 in its liquid state during manufacturing.

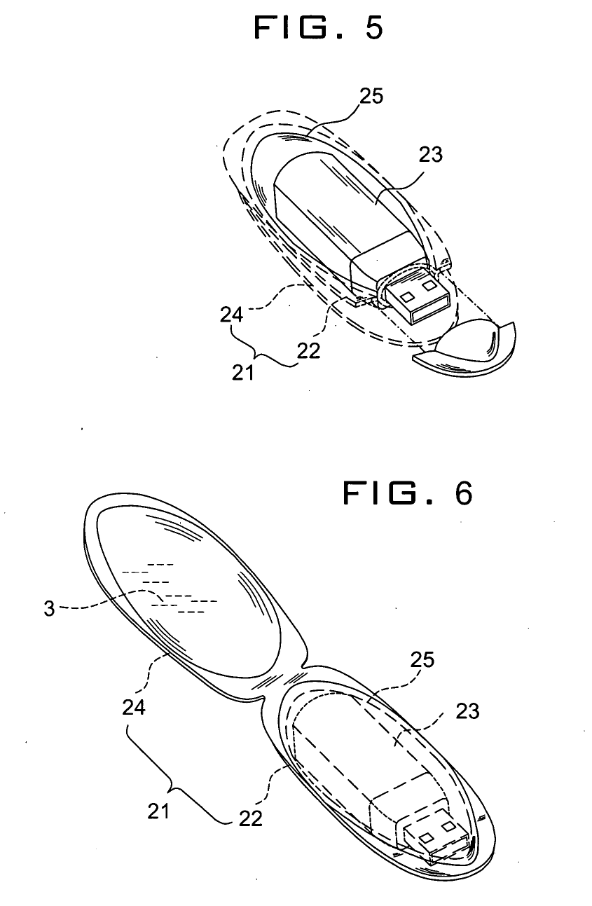

Notches 30 on the tube can be formed for easy opening. Alternatively, as seen in FIG. 5 a non-notched smooth exterior can be formed. In the smooth exterior embodiment, the opening can still be scored to allow easy opening.

The electronic device 23 may be a flash memory chip or card, or a USB key, or a microprocessor. The semiconductor electronic device 23 is housed at the core of the bar of soap for later retrieval by the user, who can replenish the used soap with a fresh supply. To conserve soap, the soft epoxy capsule preferably forms a sliver shaped remnant minimizing wasted soap. The epoxy intermediate layer is scored to open at an opening. An opening line can be formed during packaging. The user may then peel away the epoxy to access the semiconductor electronic device.

As seen in figure six, the electronic device embodiment can be manufactured in conjunction with the lotion, hand soap embodiment. A double insert 21 FIG. 6 can have both a hand soap 3 in tube 24 and at another end also enclose a USB key 23 within resin 25 and tube 22.

Therefore, while the presently preferred form of the soap bar with insert has been shown and described, and several modifications thereof discussed, persons skilled in this art will readily appreciate that various additional changes and modifications may be made without departing from the spirit of the invention, as defined and differentiated by the following claims. It is to be understood that the present invention is not limited to the sole embodiment describe above, but encompasses any and all embodiments within the scope of the following claims.

1. A soap bar comprising:
a. a soap outside layer;
b. a tube with a sealed opening, wherein the tube holds a liquid.

2. The soap bar of claim 1, wherein the tube is sliver shaped.

3. The soap bar of claim 1, wherein the tube has a thin walled heat laminated construction.

4. The soap bar of claim 1, wherein the tube is sliver shaped and has a thin walled heat laminated construction.

5. The soap bar of claim 1, wherein the tube holds liquid soap.

6. The soap bar of claim 1, wherein the tube holds liquid lotion.

7. A soap bar comprising:
a. a soap outside layer;
b. an epoxy intermediate layer;
c. a semiconductor core.

8. The soap bar of claim 7, wherein the epoxy intermediate layer entirely encapsulates the semiconductor core, wherein the epoxy intermediate layer has an outside surface having a sliver shape.

9. The soap bar of claim 8, wherein the epoxy intermediate layer houses a USB Key.

10. The soap bar of claim 8, wherein the epoxy intermediate layer houses a microprocessor.

11. The soap bar of claim 7, wherein the epoxy intermediate layer is scored to open at an opening line.

12. The soap bar of claim 11, wherein the epoxy intermediate layer entirely encapsulates the semiconductor core, wherein the epoxy intermediate layer has an outside surface having a sliver shape.

13. The soap bar of claim 12, wherein the epoxy intermediate layer houses a flash memory card.

14. The soap bar of claim 12, wherein the epoxy intermediate layer houses a USB Key.

15. The soap bar of claim 12, wherein the epoxy intermediate layer houses a microprocessor.

16. The soap bar of claim 7, wherein the epoxy intermediate layer houses a USB Key.

17. The soap bar of claim 7, wherein the epoxy intermediate layer houses a flash memory card.

18. The soap bar of claim 7, wherein the epoxy intermediate layer houses a microprocessor.

19. A soap bar comprising:
a. a soap outside layer;
b. an epoxy intermediate layer; inside the soap outside layer;
c. a semiconductor core inside the epoxy intermediate layer; and
d. a tube with a sealed opening inside the soap outside layer, wherein the tube holds a liquid.

20. The soap bar of claim 19, wherein the epoxy intermediate layer entirely encapsulates the semiconductor core, wherein the epoxy intermediate layer has an outside surface having a sliver shape.
